(19) United States
(12) Patent Application Publication
(10) Pub. No.: US 2021/0007275 A1
(43) Pub. Date: Jan. 14, 2021

(54) Process for continuously supplying batches of nutrient rich irrigation water to a Deep/Shallow Water Culture Growing System

(71) Applicant: Christian D. Lange, Carol Stream, IL (US)

(72) Inventor: Christian D. Lange, Carol Stream, IL (US)

(21) Appl. No.: 16/508,388

(22) Filed: Jul. 11, 2019

(51) Int. Cl. A01C 23/00; A01C 23/04

(52) U.S. Cl. CPC A01C 23/007; A01G 31/00; A01C 23/047; A01C 23/042

(57) ABSTRACT

A process for continuously supplying batches of nutrient rich irrigation water to a deep/shallow water culture growing system is disclosed. This system sends pre-dosed nutrient rich volumes one by one after they have dissipated the nutrients into each individual batch. These batches are nutrient ready and help maintain a nutrient level in the larger system by accurately raising nutrient levels to these smaller volumes.

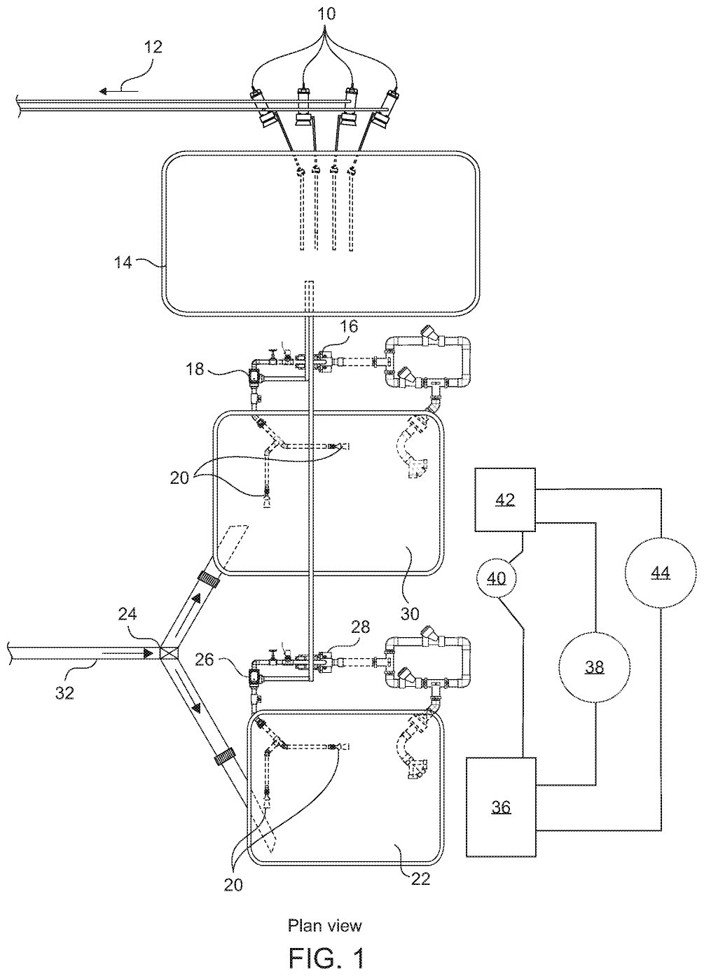

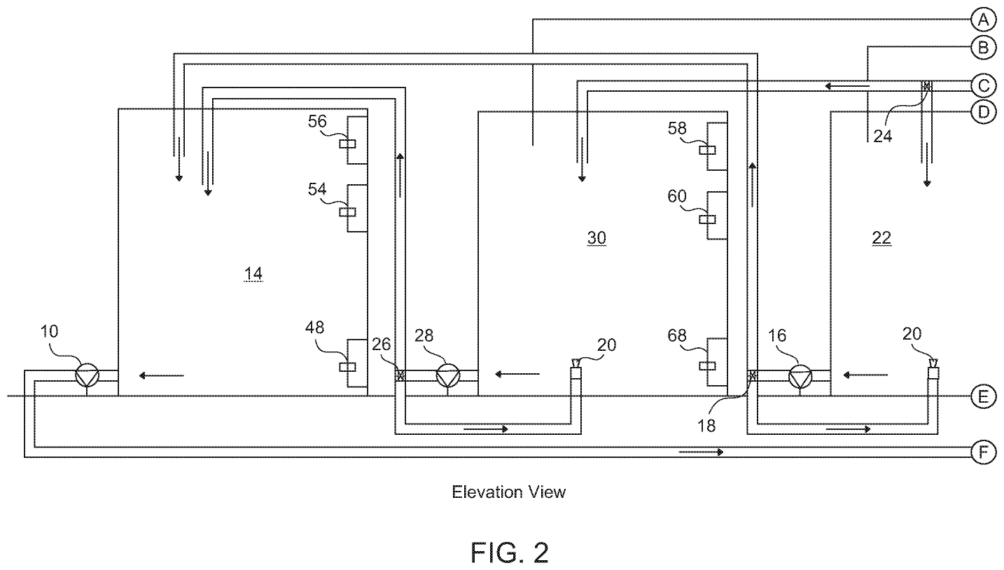

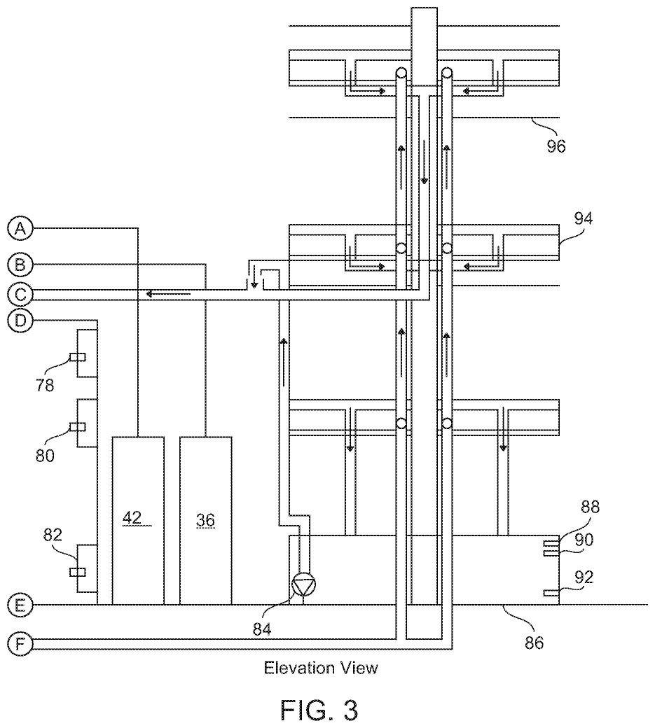

### BACKGROUND OF THE INVENTION

Problem Solved: Modern nutrient water dosing systems cannot work with large water volume systems. They can only dose nutrient solutions for a period of time, then they must wait to measure the results of the dosing. This takes a lot of time in large volume systems such as deep/shallow water culture systems.

Other nutrient dosing machines supply nutrients directly into the deep/shallow water culture systems and wait until the dose has dissipated into the system and the water that was dosed has re-circulated to the point of dosing. This method is designed for systems with less total volume of water given the time it takes for re-circulation.

The proposed system herein sends pre-dosed nutrient rich volumes one by one after they have dissipated the nutrients into each individual batch. These batches are nutrient ready and help maintain a nutrient level in the system by accurately raising nutrient levels to these smaller volumes.

### DETAILED DESCRIPTION OF THE INVENTION

As stated above, modern nutrient water dosing systems cannot work with large water volume systems. They can only dose nutrient solutions for a period of time, then they must wait to measure the results of the dosing. This takes a lot of time in large volume systems such as deep/shallow water culture systems. The invention claimed here solves this problem.

This invention uses three smaller tanks (14, 22, 30) to supply the large deep/shallow water culture system (12). Two (22, 30) of the three tanks receive the return water (32) from the main deep/shallow water culture system (12) and are measured for nutrients and are supplied nutrients to a desired level as they fill with the return water (32) from the deep/shallow water culture system (12). Once one is filled and reaches a desired nutrient level, they move their water to a third tank (14) while the return water switches (24) to the other nutrient mixing tank (22, 30). The third tank that receives the nutrient rich water from one of the two nutrient mixing tanks supplies the entire deep/shallow water culture with nutrient rich water. This process allows continuous nutrient rich water to flow continuously into a large volume deep/shallow water culture system without having to wait extended periods of time for measuring the distribution of nutrients to the deep/shallow water culture system.

The claimed invention differs from what currently exists. My invention can continuously supply pre-made nutrient rich water solutions to a large volume deep water culture horticulture farm. Other systems rely on dosing into the system and waiting on that return water to come back to the point of dosing to measure its effect on the system.

This invention is an improvement on what currently exists. My invention can continuously supply pre-made nutrient rich water solutions to a large volume deep water culture horticulture farm. Other systems rely on dosing into the system and waiting on that return water to come back to the point of dosing to measure its effect on the system.

These other systems are not designed for industrial scale deep/shallow water culture growing systems. They are designed for systems that can dissipate the nutrient delivery faster given the smaller amount of water.

The proposed system sends pre-dosed nutrient rich volumes one by one after they have dissipated the nutrients into each individual batch. These batches are nutrient ready and help maintain a nutrient level in the larger system by accurately raising nutrient levels to these smaller volumes.

### The Version of the Invention Discussed Here Includes:

A. 3-Way Valve Drain from Deep/Shallow Water Culture System (24 on diagram)
B. 1 of 2 Nutrient Mix Tanks that Receives Return Drain Water from the Deep/Shallow Water Culture System (22 on diagram)
C. 2 of 2 Nutrient Mix Tanks that Receives Return Drain Water from the Deep/Shallow Water Culture System (30 on diagram)
D. 1 of 1 Nutrient Ready Supply Tank for Supplying the Deep/Shallow Water Culture System (22 on diagram)
E. 3-Way Valve for Nutrient Mix Tanks (18 & 26 on diagram)
F. Pump for Nutrient Mix Tanks (16 & 28 on diagram)
G. Pumps for Nutrient Ready Supply Tank (10 on diagram)
H. Nutrient Dosing and Measurement Machine for Each Nutrient Mix Tank (36, 42 on diagram)
I. Eductor Mix Nozzles for Nutrient Mix Tanks (20, 34, 66, 74 on diagram) **should all be one number, request to patent drawings Jun. 2, 2019
J. Deep/Shallow Water Culture System (12 on diagram)
K. Deep/Shallow Water Culture Drain Pump (84 on diagram)
L. LOW LEVEL SWITCH (DWC, MIX TANK, NUTRIENT READY TANK) (92, 48 & 68, 82 on diagram)
M. HIGH LEVEL SWITCH (DWC, MIX TANK, NUTRIENT READY TANK) (90, 54 & 60, 80 on diagram)
N. OVERFLOW SWITCH (DWC, MIX TANK, NUTRIENT READY TANK) (88, 56 & 58, 78 on diagram)

### Relationship Between the Components:

The 3-Way Valve Drain (24) sends water from the Deep/Shallow Water Culture System to one of the two Nutrient Mix Tanks (22, 30). Each Nutrient Mix Tank (22, 30) has a pump (16, 28) and a 3-way valve (18, 26). The 3-way valve (18, 26) either allows the pump (16, 28) to recirculate and mix the water in the mix tanks (22, 30) via eductor mixing nozzles (20, 34) while the Nutrient Doser/Monitor (36, 42) measures/supplies nutrients to the mix tanks or the 3-way valve (18, 26) allows the pump (16, 28) to send the nutrient enriched water to the nutrient ready supply tank (14). The pumps for the nutrient ready supply tank (10) send the nutrient rich water supply to the Deep/Shallow Water Culture System (12).

During mixing in the Mix Tanks (22, 30), the 3-Way Valve Drain (24) empties into one of the Mix Tanks (#2, #3) until the high level switch is activated, then the 3-Way Valve Drain (#1) is directed towards the other Mix Tank (22, 30) and starts to fill it while the Nutrient Doser/Monitor (36, 42) measures/supplies nutrients to the Mix Tank (22, 30).

### How the Invention Works:

The 3-Way Drain Valve (24) allow switching the direction of the return drain water from the Deep/Shallow Water Culture System (12) to either mixing tank (22, 30), switching from mix orientation to supply orientation at the mixing tanks (22, 30).

The Nutrient Doser/Monitor (36, 42) allows measuring the nutrient level in each mixing tank to prescribe doses of nutrients to reach a certain level in the mixing tanks (22, 30).

The pumps (16, 28) are uses to either mix the dosed nutrients with the water via eductor nozzles (20, 34, 66, 74) or the pumps are used to move nutrient rich water to the Nutrient Ready Tank (#4) where pumps (10) supply the nutrient rich water from the Nutrient Ready Tank (14) to the Deep/Shallow Water Culture System (12). The 3-Way Valve Drain (24) opens to one of the Nutrient Mix Tanks (22, 30), whichever is empty.

One of the Nutrient Mix Tanks (22, 30) is filled until a high level switch (56, 58) is activated. While filling the Nutrient Doser/Monitor (36, 42) measures concentration of nutrients and doses to meet required levels.

Once a high level switch (54, 60) is activated in one of the Nutrient Mix Tanks (22, 30) the 3-Way Valve Drain (24) switches orientation to the other Nutrient Mix Tank (22, 30) and starts to fill it following the same process as above measuring and dosing nutrients until it meets required levels.

If Nutrient Ready Supply Tank (14) is empty, the Nutrient Mix Tank (22, 30) that is full replenishes the Nutrient Ready Supply Tank (14).

This process repeats, switching the 3-Way Valve Drain (24) to whichever Nutrient Mix Tank (22, 30) is empty while the full Nutrient Mix Tank (22, 30) replenishes the Nutrient Ready Supply Tank (14) when it is empty after supplying nutrient rich water to the Deep/Shallow Water Culture System.

### How to Make the Invention:

It would be necessary to construct large, open top, water containers that reside on an elevated racking system to house the Deep/Shallow Water Culture System where the horticulture plants would reside on floating rafts with their roots submerged in the deep/shallow water culture water in the water containers (a common Deep/shallow Water Culture construction for an indoor vertical farm). There would be a raised outlet pipe in each row of water containers where the water level in the water containers would exit and an inlet pipe in each row of water containers supply nutrient rich water to the water containers. The outlet pipes would all diverge to one drain pipe (32) that would lead to the 3-Way Valve Drain (24). The inlet pipes would all be connected to the Nutrient Ready Supply Tank (14).

The 3 tanks for continuous nutrient batching (14, 20, 30) would all be close to one another where the two mixing tanks (22, 30) would both be next to one of the outlets of the 3-Way Valve Drain from the Deep/Shallow Water Culture System (12). Both mixing tanks (22, 30) would have piping connected to the nutrient ready tank for supplying it nutrient rich water for supply to the Deep/Shallow Water Culture System. Each mixing tank (22, 30) would have its own re-circulation piping connecting its pump (16, 28) to an inlet on each tank then to the 3-way valve (18, 26) then to an inlet on the mixing tank (22, 30) continuing on to eductor nozzles (66, 74, 20, 34) for mixing inside the mix tanks (22, 30). The 3-way valve (16, 28) would switch from mix orientation (recirculating water for mixing as just previously stated) to nutrient ready tank (14) supply once filled and dosed to the required nutrient level.

All elements are needed.

Only the Nutrient Mix Tanks and their respective pumps, 3-way valves, eductor nozzles, and piping can be interchanged with one another.

### How to Use the Invention:

A person would use this invention where a Deep/Shallow Water Culture Growing Environment where a constant nutrient concentration in the water is needed for certain plants to grow. Someone who is utilizing the Deep/Shallow Water Culture System to grow on an industrial scale needs to pre-prescribe the water with nutrients to assure they have the right concentrations as it is difficult to wait for the dispersion of nutrients in the system to complete the entire trip through the large volume of water to properly measure the concentration of the nutrients that was dosed from the time the water entered to the inlet to when it exited the outlet of the entire system.

1. This process can precisely distribute pre-mixed nutrient rich irrigation water at desired setpoints to a large deep/shallow water culture growing system

2. This process can automatically distribute pre-mixed nutrient rich irrigation water at desired setpoints to a large deep/shallow water culture growing system

3. This process can also be used to balance the pH of the irrigation water.

4. This process allows an indoor vertical farm to not have to put irrigation tanks below floor/grade level.
